(19) United States
(12) Patent Application Publication
(10) Pub. No.: US 2008/0176040 A1
(43) Pub. Date: Jul. 24, 2008

(54) Dwelling exterior thermal protection

(76) Inventor: Patrick Ilfrey, White Bear Lake, MN (US)

Correspondence Address: Christopher J. Whewell;Western Patent Group, 6020 Tonkowa Trail, Georgetown, TX, 78628, US

(21) Appl. No.: 11/803,668

(22) Filed: May 15, 2007

Related U.S. Application Data
(63) Continuation-in-part of application No. 11/656,112, filed on Jan. 22, 2007.

(51) Int. Cl. D06N 7/02; B05D 1/36; B32B 15/00; B32B 17/00; B32B 19/00

(52) U.S. Cl. 428/148; 427/201; 427/203; 428/143; 428/149; 428/150

(57) ABSTRACT

Provided herein are multi-layer composite construction materials which are suitable as an external insulating layer on a dwelling, which includes homes, office buildings and other installations. The composite constructions of the invention comprise an insulating layer which is typically abutted or adhered to an outside surface of a dwelling, often to the exterior of a foundation or basement wall near the ground line. A composite according to the invention resists damage and abrasion from normal activities, which may include landscaping activity and normal wear and tear experienced by external building surfaces.

### CROSS-REFERENCES TO RELATED APPLICATIONS

This application is a Continuation-In-Part of U.S. patent application Ser. No. 11/656,112 filed Jan. 22, 2007 which is currently still pending, the entire contents of which are herein fully incorporated by reference.

### TECHNICAL FIELD

This invention relates generally to protective coatings for surfaces which are exposed to outdoor environments. More particularly, it relates to protective coatings applied to insulative layers on the exterior of homes and other dwellings.

### BACKGROUND

Homeowners and builders alike view basements as being valuable living space. Although basements have a general reputation for being cold and damp, this has not stopped people from locating playrooms, bedrooms, home theaters and work out areas in their basements. However, by their nature of being located at and within the ground surface upon which a dwelling or office building, etc. is disposed, basements are generally exposed to more moisture than are the remaining portions of the building.

There are several ways that water can enter into and through a basement w all. Exterior ground water can leak through wall cracks, defects, or the wall itself. Hydrostatic pressure on the wall can increase the likelihood and severity of these leaks. Condensation of moisture, from interior air on interior foundation wall surfaces, can create the appearance of a wall leak even though no leak exists. Finally, capillary action can also contribute to wall dampness and moisture problems.

High-quality waterproofing systems having drainable exterior insulation have been proven effective towards preventing issues which are associated with water penetration into basements. Typically, foundation insulation materials that are engineered to survive in a range of weather conditions are used in combination with high-quality waterproofing membranes. One material that is commonly-used as a foundation insulation material is sheet or slab stock of a foamed polymeric material, such as expanded polystyrene, and the membranes are typically a moisture-impervious polymeric materials. These types of combinations prevent ground water and vapor from penetrating the foundation wall.

A significant feature of these systems is the drainage capabilities of the insulation. Essentially, a direct path is created for water to flow to the perimeter drainage system. The insulative boards of such systems drain at a rate that prevents the build-up of hydrostatic pressure on the foundation. Due to this drainage ability, water retention in the board is far less than other exterior insulations. The waterproofing system further blocks water and vapor penetration, and the potential for condensation is greatly reduced due to the effect exterior insulation has on the inside wall temperature. The insulation effectively moves the location at which dew point conditions exist away from the interior wall surface and toward the outside of the wall, with the interior wall being effectively kept at the same temperature as the inside living space, thus greatly reducing and often eliminating moisture condensation.

However, liquid water, water vapor, sunlight, and extremities of temperature are not the only environmental elements to which the above-described foam-based exterior foundation insulation are subject. Insulation slabstock that is disposed on exposed exterior walls of basements of homes and other dwellings are also subject to mechanical impacts, shocks, and abrasions by persons who are either working or playing in the vicinity. For example, children throwing and catching footballs or otherwise playing may from time to time have a tendency to bump into or fall against the exposed portion of a home's exterior insulation. Since it is only predominantly comprised of a foamed material, such as a foamed polyolefin or expanded polystyrene, such insulation may be easily dimpled, cracked or otherwise damaged, and once damaged, turns into an unsightly eyesore that is not only not readily repairable by most homeowners, but also compromises the moisture control afforded by the system.

In addition to children, landscaping equipment is another potential source of damaging stress. For example, a manually-pushed lawnmower may scrape against the insulation near the ground level, or debris ejected from the lawn mower may strike the foam insulation, having a cumulative detrimental effect on both its appearance and performance. Importantly, power-driven edge trimming tools of the type having a rotating head with nylon string whiskers radially disposed thereabouts are in widespread use, and these devices very quickly erode the foam insulation when they contact it, which damage often results in costly repairs being necessary.

A need exists in the art for an insulative material which may be adapted to take the place of exterior foam-type insulation products on the exterior walls of basements and the like, and which functions at least equivalently to conventional foam-based exterior basement insulation with respect to insulative and moisture control properties, and which also is resistant to common sources of abrasion and damage that conventional insulation commonly undergoes. A need also exists for a method of treatment of existing insulative material in its current already-installed position and location, to confer abrasion and damage resistant properties. The present invention fulfills these needs.

### SUMMARY OF THE INVENTION

The present invention provides a multilayer composite structure useful as an insulating material. A multilayer composite structure according to the invention comprises a first layer comprising a polymeric insulating material. There is a second layer comprising an adhesive, which is disposed on the first layer. There is a third layer comprising a plurality of particles disposed on the second layer, and a fourth layer comprising an adhesive, disposed on the third layer. There is a fifth layer that comprises a plurality of mineral particles disposed on the fourth layer. In one embodiment, the first layer has an insulative rating of at least R-1. In another embodiment, the first layer has an insulative rating of at least R-3. In a further embodiment, the first layer has an insulative rating of at least R-5.

The invention also provides a process for producing a multi-layer composite insulating material. The process includes the steps of: a) providing a base layer comprising a polymeric insulating material; b) applying a first adhesive layer to the base layer; c) applying a first layer of particles onto the first adhesive layer; d) optionally, permitting the first adhesive layer to cure; e) applying a second adhesive layer over the first layer of particles; and e) applying a second layer of particles onto the second adhesive layer.

### BRIEF DESCRIPTION OF THE DRAWINGS

FIG. 1 shows a side elevation view of a composite according to one form of the invention;

FIG. 2 shows a block schematic diagram of a system for providing a curable polymeric mixture to a substrate according to one form of the invention; and

FIG. 3 shows a dwelling disposed on a slight hill having a siding material disposed on its exterior.

### DETAILED DESCRIPTION

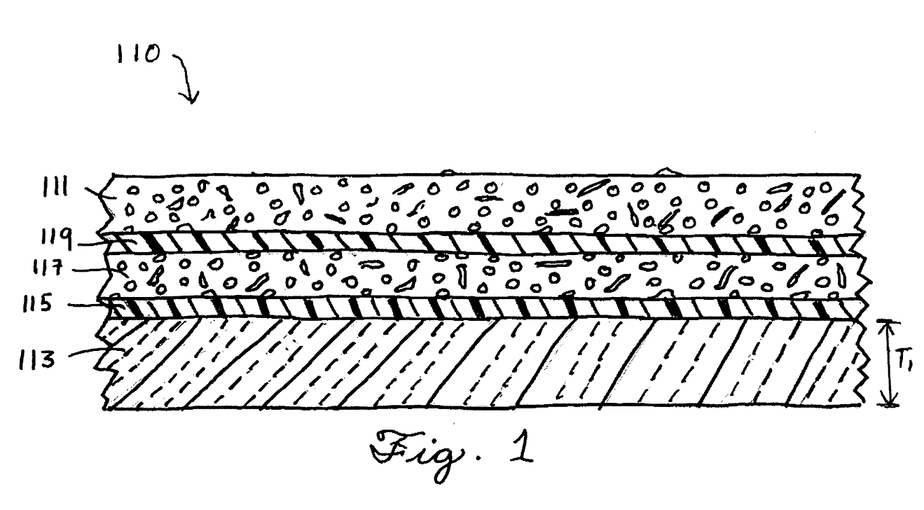

Referring to the drawings and initially to FIG. 1 there is shown a side elevation view of a composite 110 according to one form of the invention. The composite of FIG. 1 has a first layer 113, which preferably comprises a sheet or slab of insulating material stock that may be made from materials that include without limitation: foamed polyolefins, composite boards comprising pressed or bonded fibers, fiber composites including “fiberglass”, mineral wool insulation materials, expanded polystyrene, and extruded polystyrene. Sheet stocks or slabs of such materials are known in the art as being usefully employed as insulation on an exterior portion of the structure of a dwelling, such as a home or office building, and including on the exterior basement wall. However, not being limited to these materials, the first layer 113 may be comprised of any material that is capable of functioning as exterior insulation. The first layer 113 may also comprise an EFIS stucco material. The thickness dimension of the first layer T₁ may be any thickness, but is usually chosen to be any thickness in the range of between five millimeters and one hundred millimeters or greater, with a thickness in the range of between ten millimeters and fifty five millimeters being more preferred. These thicknesses are dictated by the desires of the building owner or builder, as commonly the 150 psi expanded polystyrene sheet or slab stock is supplied in a thickness of 25.4 mm when an insulative factor of R-5 is desired, and a thickness of about 51 mm when an insulative factor of R-10 is desired.

There is a second layer 115 of material that is disposed on the first layer 113. The second layer 115 preferably comprises an adhesive substance that is capable of adhering to the first layer 113 and that is also capable of binding the material used for the third layer 7, as described below. The adhesive layer may be any adhesive substance known in the adhesives arts, but preferably comprises an adhesive selected from the group consisting of: epoxy adhesives; aromatic polyurethane adhesives, aliphatic polyurethane adhesives, aromatic polyurea adhesives, aliphatic polyurea adhesives, aromatic polyaspartate polyurea adhesives, and aliphatic polyaspartate ester polyurea adhesives. Although many epoxies, polyurethanes and polyureas are considered to be useful as coatings, typically after mixing the (A) and (B) components from which such materials are made, the resulting mixture remains in somewhat of a viscous liquid state until the curing reaction has proceeded substantially to completion. The somewhat viscous liquid material has sufficient tenacity that it adheres to a substrate to which it is applied and is also capable of receiving particles of a third layer 117, as described below, which tenacity causes these particles to adhere to the second layer 115. Thus, while termed an adhesive, the second layer 115 eventually cures to form a coating after its having been applied to the first layer 113, and the adhesive substance eventually forms which might be equivalently considered as being a coating. Hence, while materials which may be considered by some persons skilled in the art as being coatings comprised of epoxies, polyurethanes, and polyureas, as mentioned, such “coatings” prior to their cure, also function as adhesives and are also useful herein as materials which may comprise the second layer 115. All coatings formulations which comprise a curable epoxy, polyurethane, or polyurea are useful for providing a second layer 115 as used in the present invention.

Polyurea and polyurethane adhesive compositions useful in accordance with the present invention for providing a second layer 115 are typically formed by admixture of an (A) component and a (B) component. Within the terminology used in the United States, the (A) component comprises an organic polyisocyanate, and the (B) component is capable of reacting with the (A) component and comprises one or more poly-ol materials in the case of polyurethanes, and one or more amino compounds in the case of polyureas, wherein each of the poly-ol(s) or amino compound(s) has a reactive hydrogen atom as part of the molecule. A hydrogen atom is considered to be a reactive hydrogen, if it is capable of participating in the Zerevitinov reaction (Th. Zerevitinov, Ber. 40, 2023 (1907)) to liberate methane from methylmagnesium bromide.

The (A) component, or organic poly isocyanate component, may consist of any number of suitable aromatic or aliphatic-based prepolymers or quasi-prepolymers. These include standard isocyanate compositions known to those skilled in the art. Preferred examples include MDI-based quasi-prepolymers such as those available commercially as RUBINATE® 9480, RUBINATE®. 9484, and RUBINATE® 9495 from the Huntsman family of companies of 10003 Woodloch Forest Drive in The Woodlands, Tex. The isocyanates employed in component (A) can include aliphatic isocyanates described in U.S. Pat. No. 4,748,192. These include aliphatic di-isocyanates and, more particularly, are the trimerized or the biuretic form of an aliphatic di-isocyanate, such as hexamethylene di-isocyanate (“HDI”), or the bi-functional monomer of the tetraalkyl xylene di-isocyanate, such as the tetramethyl xylene di-isocyanate. Cyclohexane di-isocyanate is also to be considered a useful aliphatic isocyanate. Other useful aliphatic polyisocyanates are described in U.S. Pat. No. 4,705,814. They include aliphatic di-isocyanates, for example, alkylene di-isocyanates with 4 to 12 carbon atoms in the alkylene radical, such as 1,12-dodecane di-isocyanate and 1,4-tetramethylene di-isocyanate. Also useful are cycloaliphatic di-isocyanates, such as 1,3 and 1,4-cyclohexane di-isocyanate as well as any mixture of these isomers, 1-isocyanato-3,3,5-trimethyl-5-isocyanatomethylcyclohexane (isophorone di-isocyanate); 4,4′-,2,2′- and 2,4′-dicyclohexylmethane di-isocyanate as well as the corresponding isomer mixtures, and the like. All patents mentioned in this specification are herein incorporated by reference thereto.

A wide variety of aromatic polyisocyanates may also be used in providing an adhesive formulation suitable for the second layer 115 of the present invention. Typical aromatic polyisocyanates include p-phenylene di-isocyanate, polymethylene polyphenylisocyanate, 2,6-toluene di-isocyanate, dianisidine di-isocyanate, bitolylene di-isocyanate, naphthalene-1,4-di-isocyanate, bis(4-isocyanatophenyl)methane, bis(3-methyl-3-iso-cyanatophenyl)methane, bis(3-methyl-4-isocyanatophenyl)methane, and 4,4′-diphenylpropane di-isocyanate. Other aromatic polyisocyanates used in the practice of the invention are methylene-bridged polyphenyl polyisocyanate mixtures which have a functionality of from about 2 to about 4. These latter isocyanate compounds are generally produced by the phosgenation of corresponding methylene bridged polyphenyl polyamines, which are conventionally produced by the reaction of formaldehyde and primary aromatic amines, such as aniline, in the presence of hydrochloric acid and/or other acidic catalysts. Known processes for preparing polyamines and corresponding methylene-bridged polyphenyl polyisocyanates therefrom are described in the literature and in many patents, for example, U.S. Pat. Nos. 2,683,730; 2,950,263; 3,012,008; 3,344,162 and 3,362,979. Usually methylene-bridged polyphenyl polyisocyanate mixtures contain about 20 to about 100 weight percent methylene di-phenyl-di-isocyanate isomers, with the balance being polymethylene polyphenyl di-isocyanates having higher functionalities and higher molecular weights. Typical of these are polyphenyl polyisocyanate mixtures containing about 20 to about 100 weight percent di-phenyl-di-isocyanate isomers, of which about 20 to about 95 weight percent thereof is the 4,4′-isomer with the remainder being polymethylene polyphenyl polyisocyanates of higher molecular weight and functionality that have an average functionality of from about 2.1 to about 3.5. These isocyanate mixtures are known, commercially available materials and can be prepared by the process described in U.S. Pat. No. 3,362,979. One preferred aromatic polyisocyanate is methylene bis(4-phenylisocyanate) or MDI. Pure MDI, quasi-prepolymers of MDI, modified pure MDI, etc. are useful to prepare suitable adhesives. Since pure MDI is a solid and, thus, often inconvenient to use, liquid products based on MDI or methylene bis(4-phenylisocyanate) are also useful herein. U.S. Pat. No. 3,394,164 describes a liquid MDI product. More generally, uretonimine modified pure MDI is included also. This product is made by heating pure distilled MDI in the presence of a catalyst. The liquid product is a mixture of pure MDI and modified MDI. Of course, the term isocyanate also includes quasi-prepolymers of isocyanates or polyisocyanates with active hydrogen containing materials. Any of the isocyanates mentioned above may be used as the isocyanate component in forming a polyurea or polyurethane adhesive or adhesive-forming formulation useful as a second layer 115 according to the present invention, either alone or in combination with other aforementioned isocyanates.

When the material to be used as an adhesive of the second layer 115 according to the present invention is selected to be a polyurea, the (B) component, or amine resin component, typically comprises one or more organic polyamino compound(s) which have at least one active hydrogen on each of two nitrogen atoms present on a single molecule of such compound(s), or in a mixture of two or more such polyamino compounds. Any polyamine compound having at least two nitrogen atoms in its molecular structure, wherein each of at least two of the nitrogen atoms present in the molecule have at least one active hydrogen atom attached to them, are suitable as components of the (B) component from which a polyurea adhesive or adhesive-forming formulation useful as a second layer 115 according to the present invention may be derived. This description includes without limitation blends comprised of mid- to high-molecular weight polyether polyamines, low-molecular weight amine chain extenders, and other optional additives such as pigments, adhesion promoters, and light stabilizers. The polyether polyamines may serve as the mid- to high-molecular weight amine components and are a key building block in the coating's soft block segments. In a preferred embodiment, suitable polyether amines include those commercially available from Huntsman, including without limitation JEFFAMINE® D-230 amines, JEFFAMINE® D-400 amines, JEFFAMINE® D-2000 amines, JEFFAMINE® T-403 amines and JEFFAMINE® T-5000 amines, and substantial functional equivalents from other suppliers. In addition, polyureas made from raw materials comprising polyaspartates may be employed. Polyaspartate ester polyureas useful in accordance with the present invention include, without limitation, those prepared using materials and/or components described in U.S. Pat. Nos.: 6,790,925; 6,774,206; 6,774,207; 6,737,500; 6,605,684; 6,590,066; 6,458,293; 6,399,736; 6,355,829; 6,183,870; 6,169,140; 6,013,755; 5,580,945; 5,847,195; 5,736,604; 5,733,967; 5,652,301; 5,561,214; 5,559,204; 5,529,739; 5,516,873; 5,489,704; and 4,324,716, all of which whose entire contents are herein incorporated by reference thereto.

When the material to be used as an adhesive of the second layer 115 according to the present invention is selected to be an epoxy, one component of the two part mixture form which the curable blend is formed, the (A) component, may be any material of mixture of two or more materials which contains at least two epoxy groups in its(their) molecular structure, including without limitation epoxy NOVOLAC D.E.N.® 438 resin, ARALDITE® EPN 1180 resin, and NOVOLAC D.E.N.® 431 resin, as well as other epoxy resins and precursors specified in US Patent Application US 2005/0234216, the entire contents of which are herein incorporated by reference thereto. The (B) component may be any organic polyamine that is known to be useful in the art for producing curable epoxy compositions, including without limitation all polyamino compounds described, specifically recited, and/or incorporated herein by reference, including primary and secondary polyamines, whether they are aliphatic, aromatic or polyether polyamines.

When the material to be used as an adhesive of the second layer 115 according to the present invention is selected to be a polyurethane, the (A) component may contain any of the organic polyisocyanates mentioned above, and the (B) component may comprise any polyol recognized by those of ordinary skill in the art as being useful in preparing polyurethane adhesives or coatings, including polyester polyols, Mannich condensate polyols, and polyether polyols (polyoxyalkylene polyether polyols). Exemplary materials are those marketed by Huntsman under the JEFFOL® trademark. Polyols are generally formed by free radical addition polymerization of propylene oxide, ethylene oxide, or a mixture of the two in separate steps, onto a hydroxyl or amine-containing initiator or by polyesterification of a di-acid, such as adipic acid, with glycols, such as ethylene glycol or di-propylene glycol.

For those cases where selected reactants for producing epoxies, polyureas or polyurethanes for use as an adhesive of the second layer 115 according to the invention, wherein the selected reactants are not ordinarily liquids under the conditions employed, an effective amount of solvent, plasticizer (including phthalate esters and any other material known to function as a plasticizer in adhesives, coatings, and construction caulks) may be used to provide a solution, mixture, or suspension of such reactant(s), which may be then combined with an appropriate selected (B) component, or other material that reacts with the solution, mixture, or suspension to form an adhesive useful as a second layer 115 according to the invention. In addition, it is known in the art to employ various catalysts for well-known effects of adjusting gel times, cure times, work times, open times and other time-related periods, to enable the (A) component and (B) components to be mixed and worked prior to the reaction between the components to provide a thermoset material or coating formed from the cured adhesive. Adding catalysts, solvents and other materials such as catalyst inhibitors even, to adjust the working times, is a parameter that is well within the skill level of the ordinarily skilled artisan.

Typically, no surface pretreatments are necessary to be applied to the first layer 113 prior to application of the second layer 115 when the first layer 113 comprises expanded polystyrene or other first layer materials; however pretreatment steps known to those skilled in the art may optionally be performed, including solvent washing, abrading, sand blasting, corona discharge treatments and the like, to promote adhesion and long-term durability.

The second layer 115 may be applied to the first layer 113 insulating material manually, using a paintbrush, roller, or even a cloth. The first layer 113 may be in a horizontal position resting on a horizontal surface, or it may be in a vertical position, disposed in its as-installed location on a home or other dwelling. In either case, the two components of the reactive mixture for forming the polyurethane, polyurea, epoxy or other adhesive are mixed, and the mixture of which the second layer 115 is comprised is applied on to the first layer 113. In this specification and the appended claims, the second layer 115 is disclosed as being disposed “on” the first layer 113. This language is functionally equivalent to “atop”. The second layer 115 is disposed on the first layer 113 just as a coating of paint or sealer is disposed on, or atop, a board or a wall. The thickness of the second layer is any thickness in the range of between about 100 microns to about 1000 microns, with no exact thickness itself being especially preferred owing to the nature of the function of the second layer 115, which is to adhere to the first layer 113 and to also hold in place the material which comprises the third layer 117, that is subsequently applied to the second layer 115 prior to its cure. Stated another way, the adhesive second layer 115 acts as a glue for holding the material that comprises the third layer 117 to the first layer 113. In this regard, any adhesive is functional, including resin emulsions; however, the epoxy, polyurethane, and polyurea adhesive materials described above are preferred.

An alternate and preferred method of applying the second layer 115 to the first layer 113 involves the use of conventional spray equipment that is adapted to disperse reactive polymer mixtures onto substrates, such as a Gussmer H 3500 spray gun, and other similar equipment which is marketed by Graco Inc. of Minneapolis, Minn. Such equipment and similar spray equipment is often employed in applying polyurea coatings to the beds of pickup trucks and other surfaces.

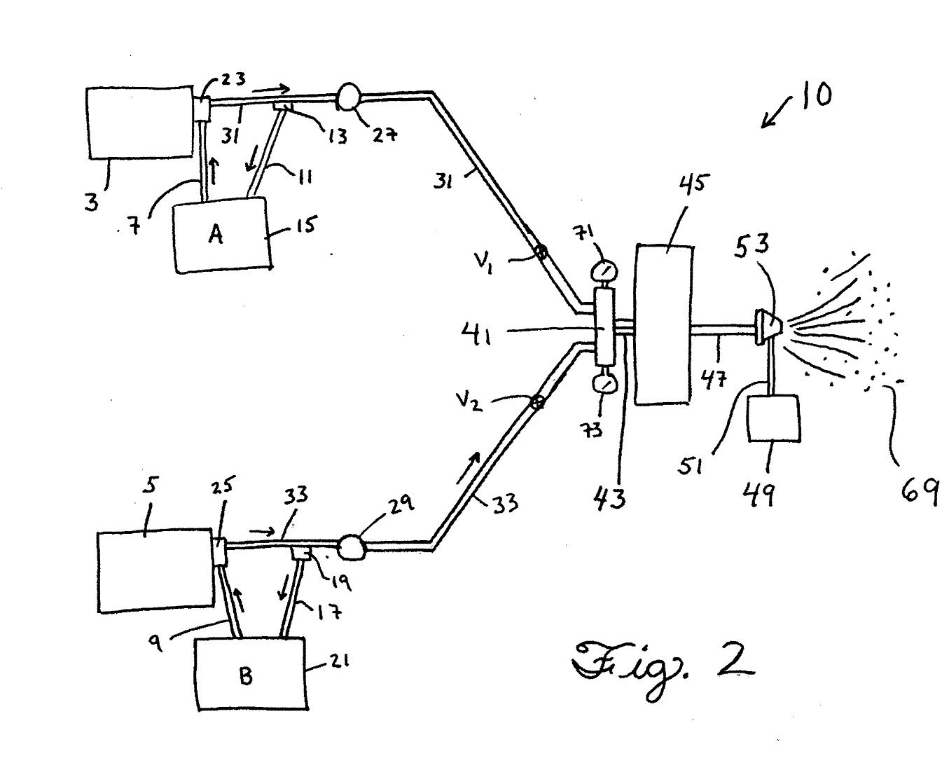

A still more preferable means for applying an adhesive second layer 115 to a first layer 113 is by using equipment shown schematically in FIG. 2. FIG. 2 shows a block schematic diagram of a system 10 for providing a curable polymeric mixture to a substrate. In the pictured embodiment there are shown a first peristaltic pump head 23 and a second peristaltic pump head 25, each of which are driven by a first pump drive 3 and a second pump drive 5, respectively. Peristaltic pumps are known in the art to be a type of positive displacement pump useful for pumping fluids. In one configuration, referred to as rotary peristaltic pumps, the fluid to be pumped is contained within a flexible tube fitted inside a circular pump casing. In the rotary configuration, a roller with a number of “rollers”, “shoes” or “wipers” as they may be called are attached to the external circumference compresses the flexible tube. As the rotor turns, the part of tube under compression closes, thus forcing the fluid to be pumped to move through the tube. Additionally, as the tube opens to its natural state after the passing of the cam, fluid flow is induced to the pump. This process is called persistalsis, and is used by Nature herself in biological systems such as the intestines. In an alternative embodiment, peristaltic pumps are made to operate in a linear fashion, as is generally known in the art. Peristaltic pumps thus typically have an inlet portion where fluid is admitted, and an outlet portion where the fluid being pumped is caused to exit the pump.

The peristaltic pump drives 3, 5 typically consist of an electric motor with associated reducing gearings, which enable the user to adjust the speed of rotation of the pump heads which are attached to them. In one embodiment of the present invention, the pump drives and heads are preferably those made by Rolatec Pump Company of North Oaks, Minn. having model number MP-V30. However, the present invention is not limited to the use of such drive-head combinations, but may be constructed and practiced using a wide range of peristaltic pumps which are commercially available. It is preferred that each pump be equipped with an electrical overload protection, such as a fuse, to act as a safety to stop pump operations if fluid pressure is greater than the desired amount, to prevent the bursting of conduits in the event of an over-pressure situation, for cases in which pressure relief valves are not used.

A system according to the invention has at least one, and preferably two peristaltic pumps as essential components. The first peristaltic pump head 23 has a first inlet line 7, which is in fluid contact with the contents contained in the first component reservoir 15, which may contain the “A” component of a reactive mixture. The contents of the first component reservoir 15 may or may not be heated or cooled, to a temperature different than that of the ambient surroundings, depending upon the component. (A convenient heating means for heating components used in providing coatings according to the invention is the DPCH10 Heavy Duty Drum Heater available from barrel Accessories and Supply Company of University park, Ill.). The first peristaltic pump head 23 also has a first feed line 31 attached to its outlet portion, which ultimately may terminate in a junction block 41 (which may comprise a manifold) or a mixer 45. Along the first feed line 31 is preferably disposed a pressure relief valve 13, which may be set to any desired pressure level such that when the set pressure level is exceeded, the valve is opened to allow the exiting of fluid material from the first feed line 31 and back into the first component reservoir 15 via first return line 11. A pressure relief valve useful in this regard is model number C46BABVSSEE made by the Wanner Engineering of Minneapolis, Minn. It is of benefit to have a first pressure gauge 27 disposed at any point along the length of the first feed line 31, and to optionally locate another pressure gauge at any other point therealong, to enable monitoring of pressure differences in the line during operation of the system 10.

In one embodiment, the first feed line 31 is comprised of a soft, ester-based polyurethane peristaltic tubing, such as part number 5792K42 available from McMaster-Carr of Elmhurst, Ill., and has any inner diameter in the range of between about three and fifty millimeters or larger; however, any tubing that is useful as an element of a peristaltic pump may be employed.

In one embodiment, the pressure in the first feed line 31 is maintained at any pressure in the range of between about one pounds per square inch (psi) and 80 psi preferably by controlling the speed of rotation of the rotary element(s) of the first peristaltic pump head 23. In another embodiment, the pressure in the first feed line 31 is maintained at any pressure in the range of between about ten pounds per square inch (psi) and 60 psi. These ranges, and any other ranges herein set forth, shall be construed as also explicitly including every possible other expressable range therebetween. In this instant case, for purposes of example and not delimitive whatsoever, such ranges include, without limitation, the ranges 5-50 psi, 5-80 psi, 5-10 psi, 10-60 psi, 10-80 psi, 10-30 psi, 20-50 psi, 20-80 psi, 30-40 psi, 30-70 psi, and any range of any span and any initial and terminal value in the range of one to 80 psi, including every tenth psi unit increment therebetween.

There is also a second peristaltic pump head 25 which has a second inlet line 9, which is in fluid contact with the contents contained in the second component reservoir 21, which may contain the “B” component of a reactive mixture. The contents of the second component reservoir 21 may or may not be heated or cooled, to a temperature different than that of the ambient surroundings, depending upon the component. The second peristaltic pump head 25 also has a second feed line 33 attached to its outlet portion, which ultimately may terminate in a junction block 41 (which may comprise a manifold) or a mixer 45. Along the second feed line 33 is preferably disposed a pressure relief valve 19, which may be set to any desired pressure level such that when the set pressure level is exceeded, the valve is opened to allow the exiting of fluid material from the second feed line 33 and back into the second component reservoir 21 via second return line 17. It is of benefit to have a second pressure gauge 29 disposed at any point along the length of the second feed line 33, and to optionally locate another pressure gauge at any other point therealong, to enable monitoring of pressure differences in the line during operation of the system 10.

The in-line safety/recirculation pressure relief valves 13, 19 are an important aspect of a system according to the invention. In addition to the pumps' internal fuse breaker, which will trip when 1.5 amperes of current is reached and stop the pumps when the pressure in the tubing is about 85 to 100 psi, the relief valves 13, 19 can be manually set to trip at any pressure in the range of between about 50 psi to about 130 psi, directly downstream of the pumps' output. When one of these valves reaches an over-pressured situation, the fluid is caused to flow back to the component reservoir, thus relieving the pressure in the tubing. This is of benefit when it is desired to stop spraying material, and the valves V₁ and V₂ (as described below) are used to stop the flow of the component(s) from the reservoir(s) to the spray nozzle, for in this situation, the relief valves merely divert the material(s) back into the reservoir(s). This keeps the material(s) being pumped in a mixed state and at a constant temperature; hence the system of the invention also functions as a mixing apparatus.

In one embodiment, the second feed line 33 is comprised of a soft, ester-based polyurethane peristaltic tubing, such as part number 5792K42 available from McMaster-Carr of Elmhurst, Ill., and has any inner diameter in the range of between about three and fifty millimeters or larger; however, any tubing that is useful as an element of a peristaltic pump may be employed. In one embodiment, the pressure in the second feed line 33 is maintained at between about 1 pounds per square inch (psi) and about 80 psi, preferably by controlling the speed of rotation of the rotary element(s) of the second peristaltic pump head 25. In another embodiment, the pressure in the second feed line 33 is maintained at any pressure in the range of between about ten pounds per square inch (psi) and 60 psi. Again, for purposes of example and not delimitive whatsoever, such ranges include, without limitation, the ranges 5-50 psi, 5-80 psi, 5-10 psi, 10-60 psi, 10-80 psi, 10-30 psi, 20-50 psi, 20-80 psi, 30-40 psi, 30-70 psi, and any range of any span and any initial and terminal value in the range of one to 80 psi, including every tenth psi unit increment therebetween.

The first feed line 31 contains the chemical component that is contained in the first component reservoir 15, under pressure as described above, and the second feed line 33 contains the chemical component that is contained in the second component reservoir 21, under pressure as described above. The first feed line 31 and second feed line 33 may both terminate in a junction block 41, which may comprise manifold. The purpose of the junction block, when used, is to turn the two separate lines 31 and 33 into a single feed 43, which is then provided to a mixer 45, which may be a static mixer or a dynamic mixer equipped with an impeller or other dispersing or mixing means, as such are known in the art. As mentioned, it may be desirable to have a second pressure gauge disposed along the feed lines 31, 33 and in this regard it is possible to locate such pressure gauges in the junction block 41. Thus, the pressure gauge 71 measures the pressure of the first feed line 31, and the pressure gauge 73 measures the pressure of the second feed line 33, at the junction block. These gauges are helpful in knowing pressure in the system in many instances, such as when the ballcock valves V₁ and V₂ (Series 550 valves, 550-100hf-α-01 from TAH Industries, Inc. Robbinsville, N.J.) are open or closed, as in takedown of the system, or changing out colors or materials from the reservoirs 15, 21, adjusting pump speeds, etc.

The single feed 43 may comprise a single tube which allows the A and B components to contact one another prior to their introduction into the mixer 45. In another embodiment, the single feed 43 comprises a dividing wall within its inner confines which precludes the A and B components from coming into contact with one another prior to their entry to the mixer 45.

The mixer 45 is a chamber in which mixing to the contents of the first feed line 31 and second feed line 33 takes place. It may be a static mixer, as such are well-known in the art, or it may be a dynamic mixer, such as model no. 442-M1-ATSEE (Series 42) made by TAH Industries, Inc. When the mixer 45 is a static mixer, the force of the pumps 23 and 25 drives the materials through the mixer and into the mixer effluent line 47, which provides its contents to the atomizer nozzle 53. For instances where the mixer 45 is a dynamic mixer, the force to move the materials through the effluent line 47 (Blue Max High Pressure Spray Hose, from Graco of Minneapolis, Minn. or equivalent) may come from the energy of the mixer itself. In any event, the atomizer nozzle 53 is provided with compressed air or other gas from a compressed air reservoir or compressor 49, which is conveyed through compressed gas feed line 51. which may be an ordinary air hose made of PVC or like materials known as being useful in pneumatic hoses. This causes the mixture comprising the A and B components to be dispersed into droplets, which collectively comprise a spray 69, which spray 69 may then be conveniently applied to any surface that is desired to have a coating produced from components A and B on it. Such surfaces include without limitation: walls, floors, truck beds, trailers, railcars, automobile frames, construction frames, pond-liners, architectural decks, wheeled-vehicles, cargo containers, and literally any surface whose corrosion properties, wearability, or physical appearance may be enhanced by a coating.

The atomizer nozzle 53 may be any nozzle known in the art that is suitable for providing a spray of a viscous liquid, preferably, but not necessarily under the influence of a compressed gas, such as compressed air, or in the case of mistures which are reactive with oxygen or water, dry nitrogen. In one preferred embodiment, the atomizer nozzle is model number 161-224AA-3 made by TAH Industries, Inc. of Robbinsville, N.J., used in combination with the high flow spray air cap, model 171-AN-F2 also from TAH Industries, Inc. Compressed air supplied to the atomizer nozzle 53 may be supplied at any pressure at which the nozzle is capable of providing a spray.

Use of a system according to the invention is advantageous over methods in the prior art, in which an A component is mixed with a B component using conventional mixing equipment and then the mixture is subsequently spread manually on a floor wall, or other surface. In contrast, a coating, including adhesive coatings, applied using such a system has more time to cure on the surface to which it has been directed, for in the prior art method the material begins to cure immediately upon mixing, in the bucket or other vessel. Having more time to cure in its final intended resting position translates into a coating of increased integrity. Further, the concept of “pot life” is no longer a consideration. This alleviates the need to have as many employees or other personnel to carry out the coating process.

The peristaltic pump heads and drive means preferably are each equipped with remote on/off switches to control pump flow. Since peristaltic pumps are self-priming, they can be permitted to run dry without fear of seizing or damaging internal components. Since there is no fluid communication between the pump components and the fluid contained in the tubing, A or B, there is no chemical contamination of the pump's components possible. Changing color of coatings or identity of coatings, using a system 10 according to the invention, is as easy as changing the feed lines 31 and 33 with new tubing, and connecting a different component A or B, or both, at the inlet side of the respective peristaltic pump.

Although the various conduits 7, 9, 11, 17, 31, 33, 43, 47 are shown in FIG. 2 as being of one particular proportion to one another as regards their lengths, the present invention includes any length of any of these conduits, as the drawing in FIG. 2 is intended to illustrate diagrammatically some of the essential components of the invention and their qualitative connection and cooperation with one another. For example, it may be desirable in many instances to have the effluent line 47 to be of much longer length than the feed lines 31, 33, for instances in which the atomizer nozzle is attached to a hand-held spray gun, which is held by walking operator. The lengths of each of the aforesaid conduits may vary, depending upon the end use application; their exact lengths being not especially cricitcal. In one embodiment, it is preferred, however, that the feed lines 31, 33 do not each exceed about three meters in length. In one embodiment, it is preferred that the effluent line 47 does not exceed about twelve meters in length, with a length of about eight meters being preferred. Preferably, all of the various conduits 7, 9, 11, 17, 31, 33, 43, 47 are thermally-insulated.

Through use of the system 10 described above, it is possible to maintain a wide range of pressures in either of the feed lines 31, 33, and to cause the relative ratios of pumping speed of the pump heads 23, 25 to be variable with respect to one another in any ratio. Such a system as described above for mixing an (A) and a (B) component is called The Revolution™ plural component design pump and is available from Citadel Restoration and Repair Inc. of 3001 103^{rd} Lane NE Blaine, Minn. 55449.

Thus, a second layer 115 may be applied to a first layer 113 in a construct according to FIG. 1 in various ways, but in any event, proceeding according to a preferred embodiment of the invention requires that a third layer 117 of material be disposed on the second layer 115, preferably prior to the time that the second layer 115 is substantially cured, to enable the third layer 117 to adhere to the second layer 115 strongly, after the second layer has cured substantially. Stated another way, the second layer 115 is applied to the first layer 113, and the stickiness or tenacity of the second layer 115 holds the particles which comprise the third layer 117 in place until the second layer has cured substantially and the particles which comprise the second layer are permanently bonded to the second layer 115, thus forming a three layer composite, which may itself be used as exterior insulation, or which may be subject to further treatment as described below to yield an insulation product that is further superior than those of the prior art.

The third layer 117 is preferably comprised of solid particles, which may be particles of mineral matter, but is not limited to mineral matter, and may comprise non-mineral matter. Mineral matter includes all known minerals, as the word “mineral” is understood by geologists and others skilled in the mineral-related arts. Aggregates are minerals within this class, and all aggregates disclosed within the document entitled: “Natural Aggregates of the Conterminous United States” by William H. Langer (U.S. Geological Survey Bulletin 1594, second printing, 1993), the entire contents of which are herein incorporated by reference, are suitable for use as a third layer 117 within the context of the present invention. Suitable solid particles which may comprise the third layer 117 include without limitation sand, crushed glass, calcium carbonate, seashells, stone, crushed stone, gravel, flints, cherts, and aluminum oxides (corundums) of various particle sizes, which may be any particle size in the range of between one micron and three millimeters, and including all ranges therebetween. The exact particle size may or may not be critical to the functioning of a composite 110 according to the invention, depending upon the material selected as the material from which the third layer 117 is comprised. For example, when metal turnings are selected as the particle from which the third layer 117 is comprised, they may be of much larger size, on an average basis, than when sand is used, but may still be effective for protecting the composite 110 from abrasions. Essentially any particle size in the range of between about 100 microns to 3.0 centimeters in diameter are suitable, including every tenth millimeter increment within such range and all ranges therebetween, when the particles are substantially spherical. However, as in the case of metal turnings, or crushed glass, chipped chert, chipped flint, etc., the length diameter of the particle may be somewhat longer than its width dimension, and the particles may have any length between about 100 microns to about 4 centimeters, including every tenth millimeter increment within such range and all ranges therebetween, and any width between about

100 microns to about 4 centimeters, including every tenth millimeter increment within such range and all ranges therebetween. In one embodiment, the third layer 117 is comprised of recycled crushed glass. In another embodiment, the third layer 117 is comprised of sand, having an average particle size between about 1 and 2 millimeters, such as the “play sand” commonly sold at Home Depot and other like retail outlets. In another embodiment, the third layer 117 is comprised of a fractured flint product such as fractured flint #2 supplied by Sterling Supply in Minneapolis Minn. from the Pritchard Okla. area. In another embodiment, the third layer 117 is comprised of obsidian particles. In another embodiment, the third layer 117 is comprised of ground recycled thermoplastic polyolefins particles. In another embodiment, the third layer 117 is comprised of silica particles. Thus, the third layer 117 may be comprised of any solid material, with naturally occurring stone, being preferred, and with vitreous natural stone, such as obsidians, cherts, flints, glasses, sands and the like being especially preferred, within the size ranges mentioned above.

According to the invention, the first layer 113 is provided, then a reactive mixture comprising the uncured second layer 115 is rolled or sprayed over it. Then, while the second layer 115 is still uncured, the third layer 117 is applied until no more particles of the third layer are seen to stick to the still-tacky second layer 115. In the art, the point at which no more third layer material is seen to adhere to the tacky, uncured second layer 115 is called the point of rejection. According to a preferred form of the invention, the third layer 117 is applied to the still-uncured second layer 115, to the point of rejection. At this stage, according to one form of the invention, the artisan may allow some time to elapse, to enable the second layer 115 to cure, to any desired degree, before applying the adhesive of the fourth layer 119, which fourth layer 119 is comprised of any material herein described as being suitable for comprising the second layer 115. According to one embodiment, the second layer 115 is permitted to cure to substantial completion of the cure prior to application of the fourth layer 119. In another embodiment, the second layer 115 is permitted to partially cure prior to application of the fourth layer 119. In another embodiment, the second layer 115 is not permitted to cure at all, prior to application of the fourth layer 119. For cases when the second layer 115 is not permitted to cure at all, prior to application of the fourth layer 119, it is beneficial to apply the fourth layer 119 using The Revolution™ plural component design pump spray system from Citadel of Blaine, Minn. to promote uniformity in the fourth layer 119.

The thickness of the third layer 117 is controlled by the particle size of the material from which the third layer 117 is comprised, since the third layer 117 is applied to the second layer 115 to the point of rejection, as is appreciated by those skilled in the art. Typically, the thickness of the third layer is any thickness within the range of between about 500 microns and about one centimeter and including all ranges therebetween. Preferably, the third layer 117 is applied to the second layer 115 manually by hand; however, it may be applied using any broadcast equipment known in the art, including flour sifters and the like, when the first layer is in a horizontal position. Although the second layer 115 and the third layer 117 are shown in FIG. 1 as being discrete layers, some of the material of the third layer 117 may be interspersed within the material the second layer 115. The same is true for the fifth layer 111 with regards to the fourth layer 119. In one embodiment, where there is a high degree of interspersion, the second layer 115 and third layer 117 may themselves collectively effectively comprise a single layer, and the fourth layer 119 and fifth layer 111 may themselves collectively effectively comprise a single layer. In such embodiment, the resulting composite may be considered as a three layer structure.

In one embodiment, the composition of the fourth layer 119 is the same as the composition of the second layer 115. In another embodiment, it is different from the second layer 115, with the composition of the fourth layer 119 still being chosen from a material herein earlier described as being suitable for the second layer 115. Stated another way, the second and fourth layers may be the same or different from one another, but both are selected from materials having been earlier described as suitable for the second layer 115. Also, the thickness of the fourth layer 119 may be the same as the thickness of the second layer 115, or it may differ from the second layer 115, with the thickness of the fourth layer 119 still being within a range herein described as being suitable for the thickness of the second layer 115.

In one embodiment, the material chosen for the fifth layer 111 is the same material as was chosen as the composition of the third layer 117. In another embodiment, it is different from that the third layer 117, with the composition of the fifth layer 111 still being chosen from a material herein earlier described as being suitable for the third layer 117. Stated another way, the third and fifth layers may be the same or different from one another, but both are selected from materials having been earlier described as suitable for the third layer 117. Also, the thickness of the fifth layer 111 may be the same as the thickness of the third layer 117, or it may differ from the third layer 117, with the thickness of the fifth layer 111 still being within a range herein described as being suitable for the thickness of the third layer 117.

Thus, a general scheme for providing a composite 110 according to the invention comprises providing a first layer 113 material, and then applying a second layer 115 curable adhesive to it, followed by application of a mineral or non-mineral third layer 117 and permitting the second layer 115 to cure to a desired degree, and subsequently applying a fourth layer 119 curable adhesive to it, followed by the application of a mineral or non-mineral fifth layer 111, and permitting the intermediate multi-layer composite so formed to rest, to enable the full curing of the second layer 115 and the fourth layer 119, which upon curing provides a finished multi-layer composite construction according to the invention, which provides superior abrasion resistance when used as exterior insulation on an existing basement or outer wall of a building construction, when the first layer 113 is abutted to the building.

In one example, which is illustrative of the invention and shall not be construed as being delimitive hereof, a first layer material is selected to be expanded 150 psi polystyrene (STYROFOAM®). The expanded polystyrene is then scratched with a wire brush to increase adhesion of the second layer, which as to be applied thereto. A base coat of CFFS DC™, a castor oil based polyurethane two component mixture, for which the components are available from Citadel Floor Finishing Systems of Blaine, Minn., is applied with using of The Revolution™ Plural Component system. The CFFS DC™ is then backrolled with a ⅜″ phenolic roller, to promote uniformity. Fractured Flint #2 from Pritchard, Okla. is then broadcast to rejection into the CFFS DC™ second layer material. The second layer (base coat) is allowed to cure. Then, a fourth layer comprising CFFS CLR™ (Citadel Floor Finishing Systems Blaine, Minn.), a 100% solids aliphatic polyaspartic polyurea is applied, again using The Revolution™ Plural Component system. The CFFS CLR™ is then backrolled with a ⅜″ phenolic roller. A fifth layer comprising Fractured Flint #2 from Pritchard, Okla. is again broadcast to rejection into the CFFS CLR™ fourth layer to provide a finished composite according to the invention.

The combination of the adhesive coatings and the fractured flint gives the durability to stand up the aggressive weed whipping and heavy duty impact resistance. The coatings gives the overall structural strength to the system while the fractured flint provides a sharp uniform surface to attack weed whip string.

An added benefit of the present invention is that current systems are limited to being produced and/or applied to existing insulation on the exterior of buildings at temperatures above 50 degrees Fahrenheit, and can not be completed year around. A composite according to the present invention can be applied at temperatures down to 30 degrees below zero Fahrenheit, thus extending the window of time in which a composite according to the invention may be prepared in situ, at a dwelling site.

Another advantage is that the material which is selected as the first layer, in the above example, expanded polystyrene, can either be coated in a controlled environment away from the dwelling site, such as in a production line, and later placed on the foundation. Additionally, a composite according to the invention can be produced over existing insulation layer, which serves as the first layer within the context of the invention.

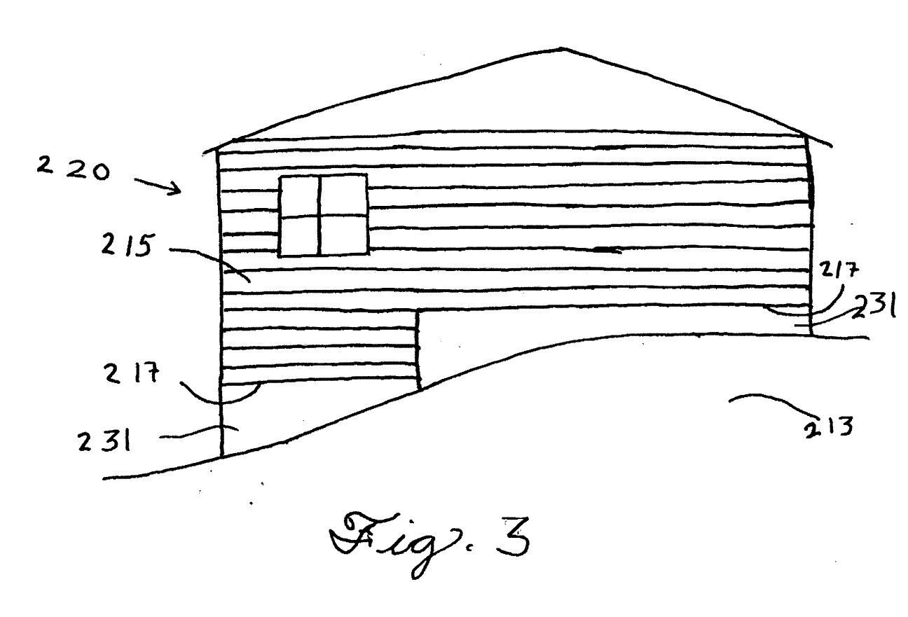

FIG. 3 shows a dwelling 220 disposed on a slight hill 213 having a siding material 215 disposed on its exterior, which may be wood siding, aluminum siding or a polymer-based siding such as vinyl siding. There is a lower edge 217 portion of the siding, adjacent to an exposed surface 231 of the basement wall. For cases where no insulation is present, the exposed surface 231 comprises the material from which the basement walls are made. In other instances, where there is insulation present, the exposed surface 231 is the insulation, which is adhered to the basement wall using conventional means as are known to those skilled in the art, including construction adhesives. It is at this location that a composite structure 110 may be disposed to provide insulation to the dwelling, with the first layer being disposed towards the wall of the dwelling and held in place by conventional means such as by construction adhesives. Optionally, colorants may be added to one or both of the adhesive layers, to match the remainder of the dwelling. In addition, the particulate material used in the third and fifth layers may be of various colors as well, especially when these materials are selected to comprise a natural stone or mineral.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes subject matter and/or features defined in or by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. Accordingly, the presently disclosed invention is intended to cover all such modifications and alterations, and is limited only by the scope of the claims which follow.

I claim:

1) A multilayer composite structure useful as an insulating material, which comprises:
a) a first layer comprising an insulating material;
b) a second layer comprising an adhesive, disposed on said first layer;
c) a third layer comprising a plurality of particles disposed on said second layer;
d) a fourth layer comprising an adhesive, disposed on said third layer; and
e) a fifth layer comprising a plurality of mineral particles disposed on said fourth layer.

2) A composite according to claim 1 wherein said insulating material comprises a material selected from the group consisting of: foamed polyolefins, expanded polystyrene, extruded polystyrene, mineral wools insulation materials, EFIS stucco materials, and fiber composite materials.

3) A composite according to claim 1 wherein said first layer has an insulative rating of at least R-1.

4) A composite according to claim 1 wherein the adhesive of said second layer is a material selected from the group consisting of: epoxy, resin emulsion, polyurethane, and polyurea adhesives.

5) A composite according to claim 1 wherein the thickness of said second layer is any thickness in the range of between 100 microns and 1000 microns.

6) A composite according to claim 1 wherein said third layer is comprised of a material selected from the group consisting of: sand, crushed glass, calcium carbonate, stone, crushed stone, gravel, flints, cherts, and aluminum oxide.

7) A composite according to claim 6 wherein said third layer material is particulant in nature and has an average particle size in the range of between one micron and three millimeters.

8) A composite according to claim 1 wherein the adhesive of said fourth layer is a material selected from the group consisting of: epoxy, resin emulsion, polyurethane, and polyurea adhesive coatings.

9) A composite according to claim 1 wherein the thickness of said fourth layer is any thickness in the range of between 100 microns and 1000 microns.

10) A composite according to claim 1 wherein said fifth layer is comprised of a material selected from the group consisting of: sand, crushed glass, calcium carbonate, stone, crushed stone, gravel, flints, cherts, and aluminum oxide.

11) A composite according to claim 10 wherein said fifth layer material is particulant in nature and has an average particle size in the range of between one micron and three millimeters.

12) A composite according to claim 1 wherein the particles which comprise said third layer material are interspersed into said second layer.

13) A composite according to claim 1 wherein the particles which comprise said fifth layer material are interspersed into said fourth layer.

14) A process for producing a multi-layer composite insulating material which comprises the steps of:
a) providing a base layer comprising a polymeric insulating material;
b) applying a first adhesive layer to said base layer;
c) applying a first layer of particles onto said first adhesive layer;
d) optionally, permitting said first adhesive layer to cure;
e) applying a second adhesive layer over said first layer of particles; and
e) applying a second layer of particles onto said second adhesive layer.

15) A process according to claim 14 wherein at least one of said first adhesive layer and said second adhesive layer is selected from the group consisting of: epoxy, resin emulsion, polyurethane, and polyurea adhesive coatings.

16) A process according to claim 14 wherein at least one of said first layer of particles and said second layer of particles is selected from the group consisting of: sand, crushed glass, calcium carbonate, stone, crushed stone, gravel, flints, cherts, and aluminum oxide.

17) A process according to claim 14 wherein the thickness of at least one of said first adhesive layer and said second adhesive layer is in the range of between about 100 microns and 1000 microns.

18) A process according to claim 14 wherein the thickness of at least one of said first layer of particles and said second layer of particles is in the range of between about 500 microns and one centimeter.

19) A process according to claim 14 wherein said base layer is disposed on an exterior surface of a dwelling.

20) A dwelling having an exterior wall, said exterior wall having a multilayer composite structure disposed therein, wherein said composite comprises:
a) a first layer comprising a polymeric insulating material;
b) a second layer comprising an adhesive, disposed on said first layer;
c) a third layer comprising a plurality of particles disposed on said second layer;
d) a fourth layer comprising an adhesive, disposed on said third layer; and
e) a fifth layer comprising a plurality of mineral particles disposed on said fourth layer,
wherein said first layer is in substantial contact with said exterior wall.
